(19) United States
(12) Patent Application Publication
(10) Pub. No.: US 2014/0308641 A1
(43) Pub. Date: Oct. 16, 2014

(54) SHOELACE TYING AIDE FOR DEVELOPMENT AND LEARNING OF THE SHOELACE TYING PROCESS

(71) Applicants: Michael Lloyd Tebben, Aurora, CO (US); Stefan Michael Lanziner, Highlands Ranch, CO (US)

(72) Inventors: Michael Lloyd Tebben, Aurora, CO (US); Stefan Michael Lanziner, Highlands Ranch, CO (US)

(21) Appl. No.: 13/863,380

(22) Filed: Apr. 16, 2013

(51) Int. Cl. G09B 19/00

(52) U.S. Cl. CPC G09B 19/0076
USPC 434/260

(57) ABSTRACT

A shoelace tying device which acts as a learning aide and assistant for individuals who may lack the capacity either mentally and/or physically to fully grasp and complete all of the steps required to tie one's shoe laces. The device consists of a solid thin piece of material which fastens to a shoe's shoelace with a clip on its backside. The device also consists of four holes on the top which pass from front to back and two hooks on the bottom end of the device. The two inner holes are used to cinch the starting knot of a double bow knot tight and hold it in place. The two outer holes and hooks are used to assist in forming and holding the loops in place while the user forms the knot using their method of choice. In addition, the front contains an image which is intended to excite and inspire the user to learn one or more of the many loop type methods used to tie one's shoelaces.

### CROSS REFERENCE TO RELATED APPLICATION

This application is entitled to the benefits and priority of the U.S. provisional patent, application No. 61/645,630 filed May 11, 2012.

### BACKGROUND OF THE INVENTION

1. Field of the Invention

A need was discovered while working with children to teach and assist in the learning process of tying shoelaces. During the design process it was also determined that the device would be useful to some people with disabilities which have many of the same challenges as a young child. While there are a couple of devices currently available, no one device was capable of doing everything required to adequately learn and master the shoe tying process simply while mimicking the same technique an adult would use.

The shoelace tying process can seem like a simple task to the average adult but in reality there are multiple steps which require good finger dexterity to accomplish the task. Therefore, a learning tool was designed and created to provide a child as much aide as possible while allowing them to focus on a single step or multiple steps in the shoelace tying process. The fact that the newly created learning tool allows the student to focus on just part of the process helps prevent the feelings of being over whelmed and frustrated.

In the development of this learning tool we also recognized that different people prefer different methods for tackling the same task. Therefore, the tool was designed to be flexible enough so that it could assist in multiple shoelace tying methods (e.g., Single Loop Method, Double Loop Method, etc.).

The device (1) has the following advantages:
The device (1) supports teaching and assisting the user with multiple methods of tying the double bow knot along with other loop type knots used on shoelaces.
The device (1) teaches the steps of tying one's shoe laces and allows the user to focus on just a portion of the shoelace tying process.
The shoe tying process learned using the device (1) looks and feels the same as when the device (1) is removed from the shoe.
The device (1) holds the loop(s) (FIG. 9; 7a,7b) in place such that the shoelace can be tied with one hand or allow the user to use two hands to manipulate a single shoelace end. Thus making it advantageous for individuals with physical disabilities (e.g., a disabled hand) or individuals that lack the finger dexterity to easily tie a shoelace.
The device (1) is capable of keeping the loops (7a, 7b) upright and in place without the user's assistance.
The device (1) is capable of keeping the loops (7a, 7b) in place when the shoe comes untied.
The device (1) cinches the starting knot (FIG. 7) which helps the user focus on other parts of the shoe lace tying process.
The device (1) helps prevent the completed knot from coming loose by cinching the starting knot (FIG. 7).
The device (1) has an appealing physical nature which helps excite and inspire a child to use it and thus learn the shoelace tying process.
The device (1) has two hooks (5a, 5b) which help the user create the right size loop for a double bow knot.
The device (1) will allow the instructor of the shoe tying process to demonstrate a single step thus allowing the student to focus on a single piece of the shoelace tying process.
The device (1) can stay attached to the shoe regardless of whether or not the laces are tied, making it readily available for the user.

2. Description of Prior Related Art

Prior art U.S. Pat. No. 7713062, issued date May 11, 2010 to Wendy Welling, is for a shoelace pull tab device for facilitating and teaching lace tying. The shoelace pull tab comprises a small flat beadlike device having two spaced apertures there through which are tapered and angled. The lace end of a lace member is threaded up through a first aperture and down through a second aperture to create a gripping pull tab which will not slide/move its position at the newly created apex of the loop in the lace. The pull tab provides a grip or pull tab for children to manipulate the laces into a bow. Indicia on the pull tabs are used as action characters or objects in a story-telling teaching method for learning shoelace tying wherein the action characters or objects engage in activities directly related to the actions necessary for tying a shoelace.

Prior art U.S. Pat. No. 4,978,304, issued date Dec. 18, 1990 to Dean D. Alexander, is for a training aid for shoelace tying includes an expandable generally cylindrical sleeve having a center passage adapted to be received upon a variety of shoes and alternatively to be placed upon a human hand. A plurality of eyelets are supported upon the sleeve and arranged generally in an equally spaced array of two rows. A flexible shoelace is secured to the sleeve through the eyelets such that the end portions of the shoelace emerge from the sleeve interior and extend outwardly there from. In an alternate embodiment, the sleeve is formed largely of a non-elastic material and includes an elastic panel which provides expansion of the sleeve to accommodate different attachments.

Prior art U.S. Pat. No. 7,309,235, issued date Dec. 18, 2007 to Kelly A. Wilk, is for an instructional system for teaching the tying of shoelaces using at least one shoelace having a first half section which is preferably light in color, for example, yellow, and a second half section, which is preferably dark in color, for example, blue. The two half sections and are permanently secured to one another to form the shoelace. Markings are located at a predetermined distance on the first half section of the shoelace to assist a person in learning to tie a shoelace.

Prior art U.S. Pat. No. 7,404,583, issued date Jul. 29, 2008 to Mendy K. Hassen, is for a shoe tying device or apparatus comprising a ring and a method of using same to facilitate the tying of laces in lace-up shoes and also a method of using same. The shoe tying device is lightweight and unobtrusive, allowing the shoe too often stay tied longer than typical without the device while generally maintaining a normal “bow” appearance. Further, the device is economical and reusable. The shoe tying device is particularly helpful for children, the visually impaired, and the mentally and physically handicapped.

Prior art U.S. Pat. No. 7,044,508, issued date May 16, 2006 to James Burns and Andrew Fung, is for a device for assisting users in tying their shoelaces properly. The device will help users tie bow-type knots by securing the initial crossover knot in place while the complete bow-type knot is being tied. The device can be used by children learning how to tie shoelace knots or by any person who is having difficulty tying shoelaces.

Prior art U.S. Pat. No. 4,553,293, issued date Nov. 19, 1985 to Ronald D. Blum, is for an improvement for tying devices which can be secured to laces particularly on shoes for holding the shoelace knot in place. The device disclosed employs a mechanism for securing a portion of the device to the shoe and enabling the device to be reused for securing a knot in place each and every time the laces are tied. In the embodiment disclosed, the invention also incorporates elastic or semi-rigid means for engaging the shoelace knot from opposed sides to impede the knot from becoming untied while simultaneously exposing the knot for view and maintaining the normal appearance of the bow.

Prior art U.S. Pat. No. 5,372,510, issued date Dec. 13, 1994 to James S. Stanfield, is for a combination shoelace and joining device is provided for use by young children or the handicapped, to aid in tying a bow in a shoelace that is mounted on a shoe. The joining device has a pair of permanently connected shoelace holding portions, with a first portion substantially permanently mounted on a shoelace part and a second portion which is child-mountable on a second shoelace part to hold a shoelace end portion in a loop configuration which aids in tying a bow. Each shoelace holding portion forms a passage part through which one of the shoelace parts extends. One joining device includes a pair of clamp parts that can be clamped around the second shoelace part, and that forms the second joining portion. The device includes a flexible strip that holds the clamp parts together and that forms the first holding portion. A teaching kit includes a joining device mounted on a short.

### SUMMARY OF THE INVENTION

The invention acts as an extra set of hands and a learning tool for tying shoelaces. In addition, the creative image on the face of the device is designed to excite and inspire the student. The device allows the instructor to demonstrate and tutor the student in a step by step manner for a variety of shoelace tying methods, while allowing the student to focus on one or more of the steps required to tie their shoe. If the student fumbles during the process the device avoids the need to completely start the tying process over. In addition, it helps create a tight knot and prevents the shoelace from coming untied. It is designed to stay on the shoe, unless intentionally removed, and will not come off even when the shoe is untied.

### BRIEF DESCRIPTION OF THE DRAWINGS

FIG. 1—front view of the device.

FIG. 2—side view of the device.

FIG. 3—back view of the device.

FIG. 4—front angled view.

FIG. 5—back angled view.

FIG. 6—depicts how the device will look attached to the shoe with the shoelaces threaded up from the shoe beneath.

FIG. 7—angled view of the device showing a sample image on the face of the device. The image also shows how the shoes laces should be threaded up through the device and the starting knot used for the common double bow shoelace knot.

FIG. 8—angled view of the device showing a sample image on the face of the device and how it will look with a tied shoelace knot.

FIG. 9—depicts the start of the Double Loop method for tying a double bow knot with the device.

FIG. 10—depicts the step required to complete the Double Loop method using the device.

FIG. 11—depicts the start of the Single Loop method for tying a double bow knot with the device.

FIG. 12—depicts the step required to complete the Single Loop method using the device.

FIG. 13—depicts the start of the Single Loop method for tying a double bow knot using the hook of the device.

FIG. 14—depicts an intermittent step required to complete Single Loop method using the hook of the device.

FIG. 15—depicts the final step required to complete the Single Loop method using the hook of the device.

FIG. 16—depicts a less known method for tying a double bow knot with the device.

FIG. 17—depicts the step required to complete the less known method using the device.

### DETAILED DESCRIPTION OF THE INVENTION

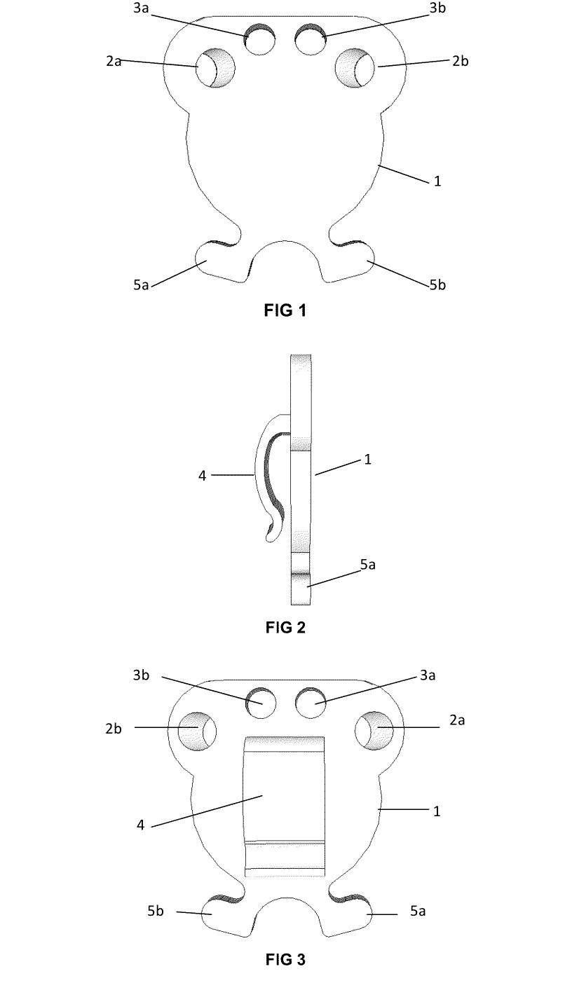

FIGS. 1-17 depict a shoelace tying device (1) made of a solid material such as plastic, wood or metal, which is intended to permanently attach to the users shoe until they decide to remove it and aide in the shoe tying process while also having an aesthetic appeal.

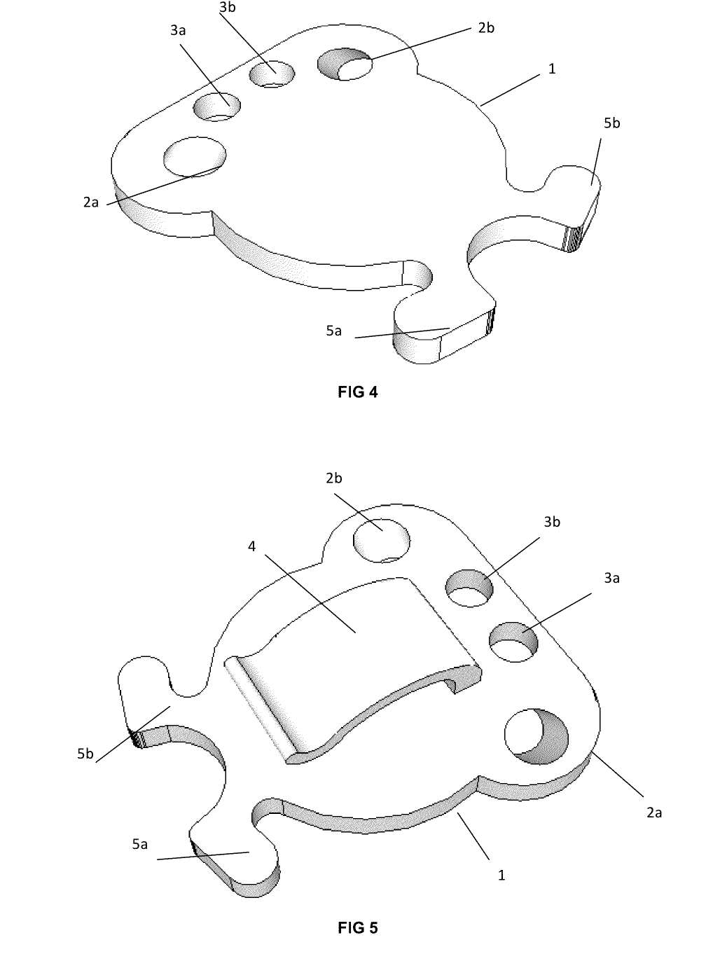

The device (1) is approximately 1.5″ wide by 1.75″ tall by 0.125″ in depth. The device (1) contains four holes (2a, 2b, 3a, 3b). The two inner holes (3a, 3b) are approximately 0.125″ in diameter and should be large enough to accommodate threading a shoelace through. The two outer holes (2a, 2b) are approximately 0.25″ in diameter and should be large enough to accommodate a shoelace while allowing it to slide through easily. The center point of the inner holes (3a, 3b) is approximately 0.125″ from the top edge and 0.25″ outward from the vertical center line of the device. When used correctly these inner holes (3a, 3b) are designed to act as a cinch for the starting part of the common shoelace knot (FIG. 4) which allows for less finger dexterity by the user and also helps to keep the shoelace tied. When clip (4) is attached to the top two crossing shoelaces the device is designed to align the two inner holes (3a, 3b) where the starting knot would normally be formed. The center point of the outer holes (2a, 2b) are approximately 0.25″ from the top edge and 0.25″ outward from the vertical center line of the device. The outer holes (2a, 2b) are angled approximately 45 degrees outward from the front of the device to the back of the device to allow the shoelace to be pulled out the backside of the device with minimum interference or obstruction from the shoe. At the bottom of the device (1) are two hooks (5a, 5b), which are designed to hold the loop down, in place and give an approximate size in which to form the loop when tying a loop type knot with the shoelace.

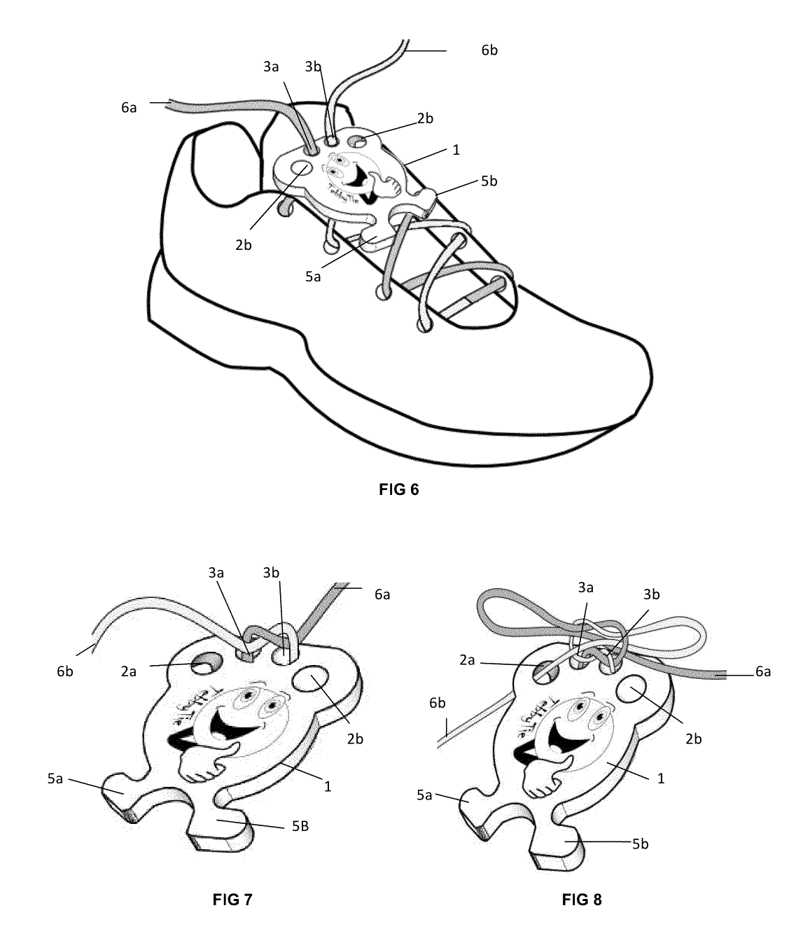

FIG. 6 portrays the device (1) attached to the shoelace using the clip (4) on the back of the device (1). The device's clip (4) is attached to the top pair of crossing shoelace segments and is designed to keep the device securely on the shoe up until the user chooses to deliberately remove it.

FIG. 7 illustrates the starting knot used to create the double bow knot. To create the starting knot with the device thread the right shoelace end (6a) up from the back of the device and through the right inner hole (3a). The left shoelace end (6b) is then threaded up from the bottom of the device and through the left inner hole (3b). The shoelace ends (6a, 6b) are crisscrossed to form an “X” by placing the left shoelace end (6b) over the right shoelace end (6a). Next, the left shoelace end (6b) goes over and under the right shoelace end (6a) to form the starting part of the knot as demonstrated in FIG. 7. This part of the knot is then cinched tight when the user pulls both shoelace ends (6a, 6b) firmly. This is how the device is used to create a tight left over right starting knot and common with a right handed person. As an alternative, the user may also create a right over left starting knot which a left handed person may have a tendency towards.

It is important to note that no matter which method the user chooses to complete the double bow knot with, the device will securely hold the starting knot tight allowing the user to focus on and master just a portion of the shoelace tying task.

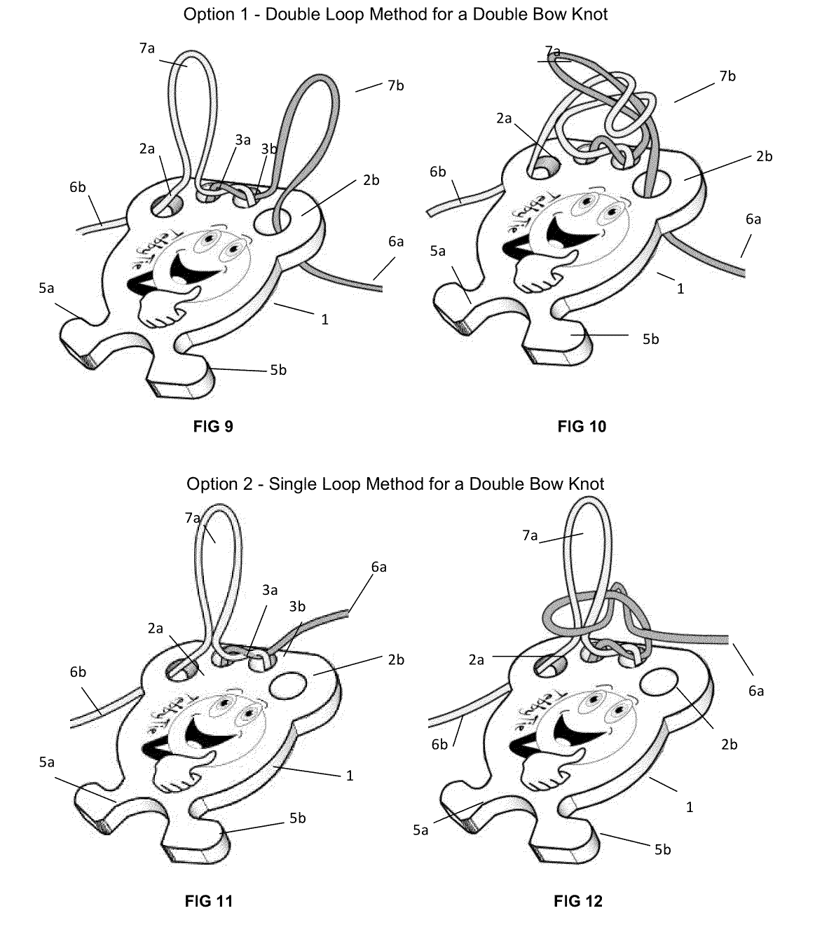

FIGS. 9-17 demonstrate just some of the potential shoelace tying methods for tying the common double bow shoelace knot, which are made possible by the device (1). The device (1) was designed to act as a tool to help not only in executing the double bow knot but in executing any type knot where a loop is required in tying the shoelace (e.g., the Scottish Knot).

Descriptions of FIGS. 9-17 to follow are explained based on the user's perspective who is wearing the shoe while tying the shoelace and most likely correspond to a right handed person's tendencies. Alternatively, the device also supports the opposing motions used for the shoelace tie process which maybe more common for a left handed person.

FIG. 9 and FIG. 10 illustrate how to complete a double bow knot using an option commonly known as the double loop method. To perform the double loop method using the device, form a left over right starting knot (FIG. 7). Next, thread the shoelace end (6a) through the outer hole (2b) to form loop (7b). Thread shoelace end (6b) through outer hole (2a) to form loop (7a). This forms and holds in place without user intervention the two loops (7a, 7b) required to perform the double loop method. If the user fumbles the loops (7a, 7b) will remain and prevent the frustration of having to repeat the forming of the loops (7a, 7b). To complete the knot, form an “X” with the left loop (7a) over the top of the right loop (7b). Next, pull the top loop (7a) over and under the bottom loop. Pull both loops firmly. As a slight alternative, the user can let the device hold the right loop (7a) and use two hands on the left loop (7b) to wrap it around and under the device held loop (7a) if need be. Thus, demonstrating one of the advantages of the device.

FIG. 11 and FIG. 12 illustrate how to complete a double bow knot using an option commonly known as the single loop method. To perform the single loop method using the device, form a left over right starting knot. Next, thread the shoelace end (6b) through the outer hole (2a). This forms and holds the single loop (7a) in place without the user's involvement. If the user fumbles the loop will remain and prevent the frustration of having to repeat the forming of the loop. To complete the knot, take shoelace end (6a) and wrap it around the pre-formed loop (7a) and then through itself by pulling the piece of shoelace end (6a) up and through which is closest to the loop (7a). Again, the user has the option of allowing the device to hold the loop (7a) in place while being able to use two hands to manipulate the shoelace end (6a) around the loop (7a) and through itself to complete the knot (FIG. 12). This allows the user to visually see and learn how the knot is formed without the frustration of simultaneously holding both shoelace ends (6a, 6b) to form the knot.

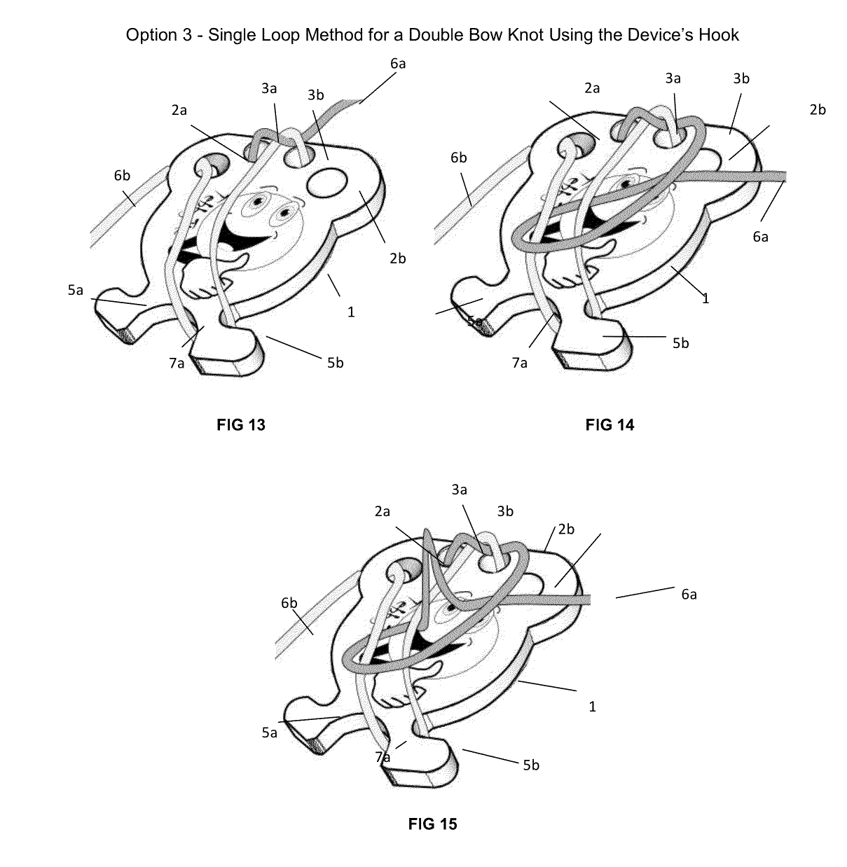

FIG. 13, FIG. 14 and FIG. 15 illustrate how to complete a double bow knot using the single loop method and the hooks (5a, 5b) of the device. To teach or perform the single loop method using the hooks (5a, 5b) of the device form a left over right starting knot. Next, thread the shoelace end (6b) over and under the hook (5b) of the device (1) and then through the right outer hole (2a). This teaches the user how large a proper loop should be and holds the single loop (7a) in place required to perform the single loop method without user intervention. In addition, it also allows the user to get a different perspective on how the knot is tied. If the user fumbles the loop (7a) will remain and prevent the frustration of having to repeat the forming of the loop (7a). Next, take shoelace end (6a) and wrap it over and under the hooked loop (7a) as demonstrated in FIG. 14. Then use one hand to lift a piece of shoelace end (6a) upward to form a new loop. While holding the new loop, remove the hooked loop (7a) and pull each loop firmly to complete the knot.

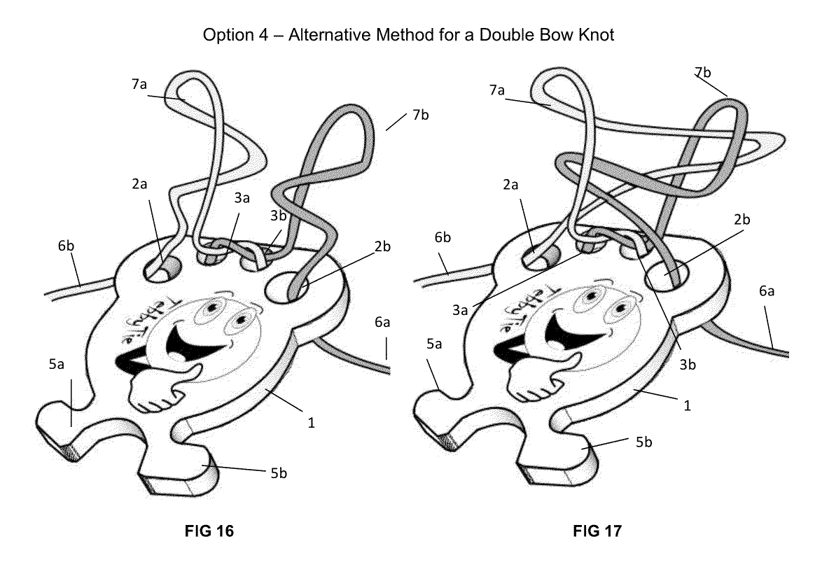

FIG. 16 and FIG. 17 illustrate how to complete a double bow knot using a less known option. To perform this option using the device, form a left over right starting knot (FIG. 7). Next, thread the shoelace end (6a) through the outer hole (2b) to form loop (7b). Thread shoelace end (6b) through outer hole (2a) to form loop (7a). This forms and holds in place without user intervention the two loops (7a, 7b) required to perform this method. If the user fumbles the loops (7a, 7b) will remain and prevent the frustration of having to repeat the forming of the loops (7a, 7b). Based on a left over right starting knot, the laces will naturally want to twist so the shoelace end (6a) is toward the heel side of the shoe and the shoelace end (6b) is toward the toe side of the shoe. As another way of stating the same, loop (7a) should form flowing from the bottom of the device (1) to the top of the device (1) as lace end (6b) stems from the starting knot and through outer hole (2a) and loop (7b) should form from top of the device to the bottom of the device as lace end (6a) stems from the starting knot and through outer hole (2b). If the loops (7a, 7b) are not formed in this manner, then manually adjust them by twisting them 180 degrees so they are. Next, take hold of the loop segments (7a, 7b) which are closest to the end of the lace. Then simultaneously push right loop (7a) segment through left loop (7b) and push left loop (7b) segment through right loop (7a). As the segments pass through the loops each segment should switch hands and the shoelace segments should be pulled firmly to complete the knot.

What is claimed is:

1. An instructional shoelace tying aide for teaching and facilitating shoelace tying comprising:
a. a planer-shaped plate made of a solid material, a clip on the back of the device, two inner holes large enough to accommodate threading a shoelace through, two outer holes edged outward from the vertical center line of the device to allow the shoelace to be pulled out the backside of the device with minimum interference or obstruction from the shoe and large enough to accommodate threading a shoelace through, and two hooks at the bottom of the device.

2. The shoelace tying aide of claim 1 wherein said two inner holes are designed to create friction and effectively act as a cinch for the starting part of the common shoelace knot keeping the shoelace starting knot tied.

3. The shoelace tying aide of claim 1 wherein said two outer holes further comprise means to hold in place the shoelace loop without user intervention.

4. The shoelace tying aide of claim 1 wherein said two hooks at the bottom of the shoelace tying aide further comprise means that the distance of the inner and outer hole to the hooks measure the approximate right size shoelace loop.

5. The shoelace tying aide of claim 1 wherein said top plate accepts decoration to having an aesthetic appeal.

6. A shoelace tying method for teaching shoelace tying comprising:
a. attaching the device to the top crossing shoelaces with the clip on the back of the device, threading up the right shoelace end up from the back of the device and through the right inner hole, threading the left shoelace end up from the bottom of the device and through the left inner hole, and the device remaining attached to the lace; threading the shoelace end through the outer hole, forming and holding in place the loop without user intervention, allowing for a shoe tying process with one or two hands.

7. The shoelace tying method of claim 6 further comprises of looping the shoelace around the bottom hook measuring the right size loop, holding in place the shoelace loop allowing the tightening of the shoelace knot by pulling on the other shoelace loop; enabling a shoe tying process that can be accomplished with one hand.
